(19) United States
(12) Patent Application Publication
(10) Pub. No.: US 2005/0220073 A1
(43) Pub. Date: Oct. 6, 2005

(54) System and method for transmitting signals

(75) Inventor: Zei Fang Hsu, Fremont, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Asicexpert, LLC., Fremont, CA (US)

(21) Appl. No.: 10/814,930

(22) Filed: Mar. 30, 2004

(51) Int. Cl. H04L 12/28

(52) U.S. Cl. 370/351

(57) ABSTRACT

There is provided a system for communicating data between electronic devices that has at least one transmitter in electrical communication with a sending electronic device. The transmitter has a data sum accumulator, a transmitter identification generator, and a data buffer for creating an identification of a desired receiver from the sum of the incoming data. Furthermore, the system has at least one receiver in communication with a receiving electronic device. The receiver has a data sum accumulator, a data buffer and a receiver identification generator for creating an identification of a desired receiver from the sum of incoming data sent by the transmitter. By easily generating the identification of the receiver, it is possible to connect multiple devices without wires or complex circuitry.

### FIELD OF THE INVENTION

The present invention generally relates to communication systems and more specifically to a system and method for transmitting audio and/or video information in a digital form over a digital network.

### BACKGROUND OF THE INVENTION

With the increase in the number of consumer electronic devices, the method for communicating between devices has become more complicated. For example, the number of components of a home audio system that communicate with one another has greatly increased. Wires are used to transmit audio and/or video signals between the components. In this regard, the wires are connected between components that generate the signals such as receivers and CD/DVD players to the devices that play the signals such as televisions and speakers.

As will be recognized, the wiring for an audio/video entertainment system having multiple components can be very cumbersome and expensive to implement. The typical audio/video system may have multiple components such as cable/satellite TV receivers, CD/DVD players, VCR's, game stations, audio amplifier, television, speakers, etc. . . . . Each of these devices needs to be wired into the system for full functionality.

Furthermore, it is becoming more common to integrate a personal computer into the entertainment system for storing audio and video data in a digital format. Usually, the content is transferred from the computer to an amplifier of the home entertainment system in order for playback. Often times, the computer is not located with the other components of the home entertainment system and running wires to the other components of the entertainment system is cumbersome. Many times, the computer system is integrated into a home network. The network can be wired (i.e., Ethernet) or wireless (i.e., Bluetooth or IEEE 802.11).

Currently, it is difficult to use the network to transfer the information from the home computer to the other components of the entertainment system. A special adaptor or other device must be used to integrate the analog components with the network. The adaptor must be able to receive signals from the network and convert the signals to an analog format. Furthermore, the computer and the adaptor should be programmed to determine the device that will receive the signals.

### SUMMARY OF THE INVENTION

There is a need for a device which can easily integrate electronic devices such as components of an entertainment system. Such a device can reduce the number of wires thereby facilitating integration. Furthermore, it would be advantageous if such device can use an existing computer network to connect components in a seamless manner.

In accordance with the present invention there is provided a system for communicating data between electronic devices. The system has at least one transmitter in electrical communication with a sending electronic device. The transmitter has a data sum accumulator, a transmitter identification generator, and a data buffer for creating an identification of a desired receiver from the sum of the incoming data. Furthermore, the system has at least one receiver in communication with a receiving electronic device. The receiver has a data sum accumulator, a data buffer and a receiver identification generator for creating an identification of a desired receiver from the sum of incoming data sent by the transmitter.

The transmitter can further include an analog to digital converter for converting the signal from the sending device into digital format. Furthermore, the transmitter may also include an encryption unit for encrypting data and a compression unit for compressing data. Similarly, the receiver may have a digital to analog converter for converting the data sent by the transmitter into an analog signal for the receiving device. Furthermore, the receiver may include a decryption unit for decrypting the data and a decompression unit for decompressing the data.

In accordance with the present invention, each transmitter has a unique transmitter embedded ID. The data is first summed and then an extra data is created in such a way that a unique receiver ID is created for the intended receivers. One extras data is also added (in addition to the extra data for the regular receivers in order to generate a unique receiver ID for the adaptor, bridge, hub our router. The regular receiver will not count this extra data for the adaptor, bridge, hub router when checking for the ID.

A classification code can be added to the receiver ID in order to differentiate the ID type. Different receivers can optionally share the same receiver ID. A receiver will only accept received data when there is a matching receiver ID of the same type. The data accepting or rejecting mechanism is done without any switching processor or module.

The transmitter can also auto-stop transmitting when there is no incoming signal activity over a set period of time and auto-wake to transmit when an incoming signal is detected. The receiver can also auto-shutdown the data output and/or digital to analog converter when there is no incoming data over a set period of time and auto-wake to transmit data and/or turn on the digital to analog converter when it receives data.

The data buffer design for both the transmitter and the receiver prevents data under-flow and over-flow conditions. When data under-flow and over-flow conditions cannot be prevented, a graceful audio and/or video concealment can be performed. If the above effort is not done, the data buffer design will allow data under-flow and over-flow conditions to occur and recover to normal operations later.

The ID's for the transmitter and receive can be either manually or automatically assigned as long as the ID's are unique among transmitters and receivers. In manually setup mode, different receivers are allowed to share same receiver ID's. The automatic assignment mechanism for the transmitter is to first detect all of the transmitter ID's from all of the data received over a set period of time. Then the transmitter will assign itself a unite transmitter ID that is different than from any of the ID's detected. The transmitter will broadcast the transmitter ID and wait for a conflict response. If there is a conflict, a new unique transmitter ID will be assigned. The automatic assignment mechanism of the receiver is similar except that the receiver ID needs to be transmitted by a transmitter. A dedicated receiver ID can also be used for time stamp synchronization. In addition to the foregoing, it is also possible to include error detection and/or a correction unit can be added to the design to safe guard the data.

### BRIEF DESCRIPTION OF THE DRAWINGS

These, as well as other features of the present invention, will become more apparent upon reference to the drawings wherein:

FIG. 1 illustrates electronic devices networked together using the present invention;

FIGS. 2-19 are block level diagrams illustrating different embodiments of the present invention;

FIGS. 20-26 illustrate network configurations utilizing the present invention; and

FIGS. 27-32 are bit diagrams illustrating the operation of the present invention.

### DETAILED DESCRIPTION

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. Programming instructions can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used herein, a “computer-readable medium” can be any means that can contain, store, communicate, propagate, or transport the program for use by or in connection with an instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer readable-medium can include the following: an electrical connection having one or more wires, a portable computer diskette, a random access memory (RAM), a read only memory (ROM), an erasable programmable read only memory (EPROM or Flash memory), an optical fiber, or a portable compact disc read only memory (CDROM).

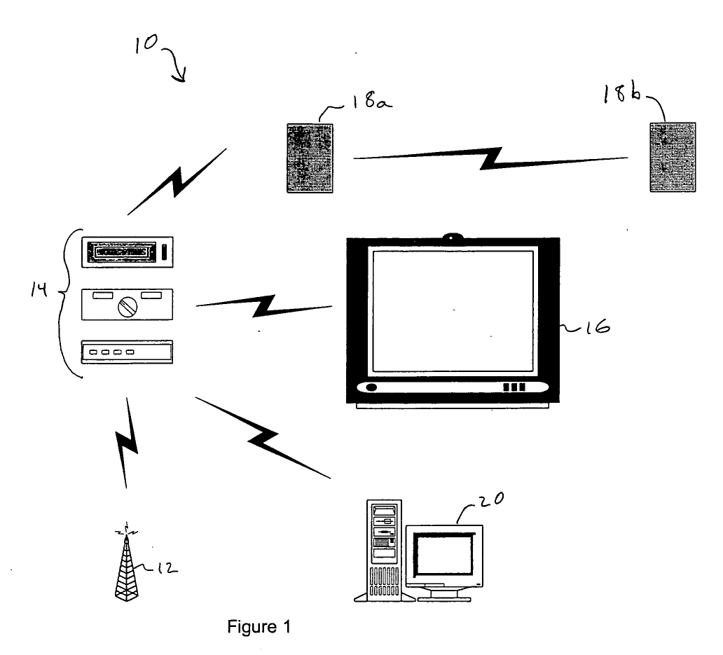

Referring now to the drawings wherein the showings are for purposes of illustrating preferred embodiments of the present invention only, and not for purposes of limiting the same, FIG. 1 illustrates a home entertainment system 10 utilizing the present invention. The entertainment system 10 has an antenna 12 capable of receiving either digital and/or analog signals that are transmitted to entertainment components 14 such as an audio receiver, satellite receiver, cable TV receiver, DVD player, CD player, DVR, game station, VCR, amplifier, etc. . . . . The number and type of components can vary upon the choice of the user. The components 14 are electronic devices that can generate either analog or digital electronic signals. The entertainment system 10 may also include a television 16 for displaying video from signals generated by the audio components 14. For example, the television may generate a picture from analog signals for conventional television or generate a picture from digital signals for a digital television. The system further includes speakers 18a, 18b for generating audio from audio signals of the components 14. The number and type of speakers can vary upon the choice of the user. The entertainment system 10 may further include a computer system 20 for storing and organizing digital media files. The computer system 20 can store MPEG and AVI files that can be played by the components 14.

As previously mentioned above, the devices of the entertainment system 10 are typically connected through the use of wires and can be very cumbersome because many wires are needed. Specifically, wires are needed between the antenna 12 and the components 14, while the speakers 18a, 18b and television 16 are also connected to the components 14 with the wires. With each electronic device of the entertainment system 10 having the present invention, the need for wires can be eliminated. Specifically, the present invention provides an transmitter or a receiver for connecting the devices in an efficient manner.

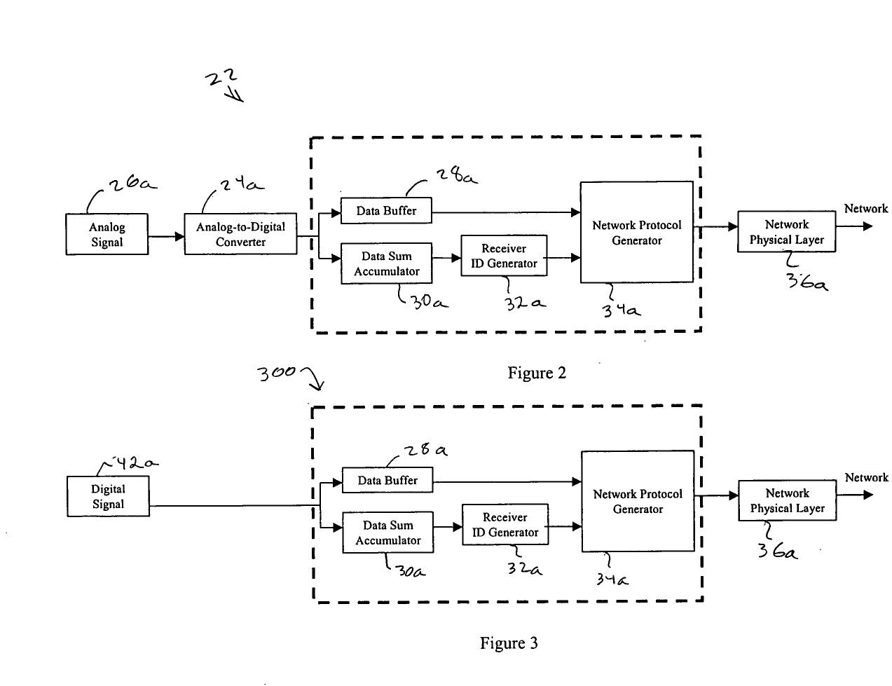

Referring to FIG. 2, a block diagram for an analog transmitter 22 constructed according to the present invention is shown. The analog transmitter 22 is configured to receive analog signals from an electronic device such as the electronic components 14 that are sending signals to other components. The transmitter 22 includes an analog to digital converter 24a for converting an analog signal 26a into a digital signal as is commonly known. For example, the analog to digital converter 24a can sample the incoming analog signal at a prescribed rate and generate the corresponding digital signal such as an 8-bit/sample.

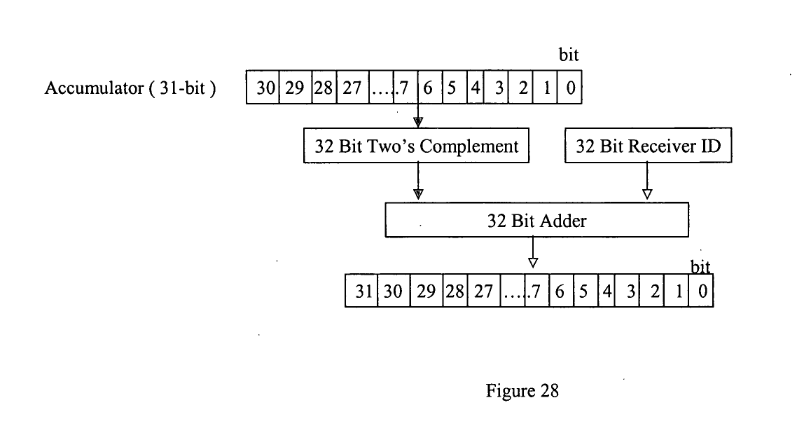

The digital signal from the analog to digital converter 24a is fed into a data buffer 28a and a data sum accumulator 30a. The data buffer 28a stores the digital data while an identification is generated, as will be further explained. Referring to FIG. 32, the data sum accumulator 30a sums all of the bits from the analog to digital converter 24a together. The number of bits of data the accumulator 30a generates is equal to the number of bits as the address of the desired receiver. The output of the accumulator 30a is fed into the receiver ID generator 32a which takes the two's complement of the data. Furthermore, the ID generator 32a adds the address of the identification of the receiver to the data, as seen in FIG. 28. The receiver ID is chosen by the user and is the device that is to receive the data. For example, referring to FIG. 1, if the user wanted to send audio data from the electronic components 14 to the speakers 18a or 18b, the user would select the address of the corresponding speaker 18a/18b on the transmitter 22 of the components 14. The output of the receiver ID generator 32a corresponds to the address of the desired receiver.

A network protocol generator 34a receives the data from the data buffer 28a and the addressing information from the receiver ID generator 32a. The protocol generator 34a combines and converts the data from the data buffer 28a and the receiver ID from the receiver ID generator 32a into a format for transport over a network. For example, if the data is to be transported over a WiFi IEEE 802.11 network, the network protocol generator 34a would convert the data into the appropriate format. The network can be either wired or wireless, as long as the transmitter and receiver are both using the same format. Some non-limiting examples of networks are Ethernet (10/100/1Gig, etc. . . . ), Bluetooth, Firewire (1394a&b), USB, and Fibre Channel. The network protocol generator 34a outputs the formatted data to the network physical layer 36a for transmission over the network.

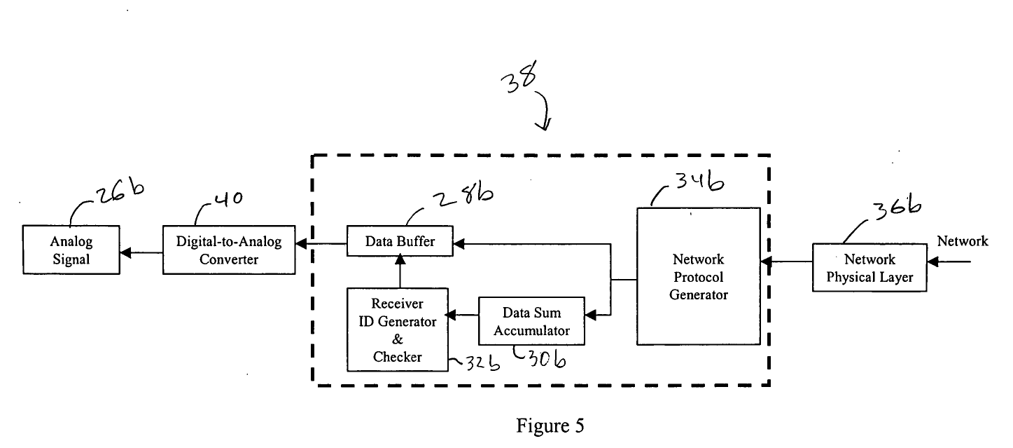

Referring to FIG. 5, a block diagram for an analog receiver 38 is shown. The analog receiver 38 generates an analog signal 26b that corresponds to the inputted analog signal 26a of the transmitter 22 of FIG. 1. The signal from the transmitter 22 is received over the network at the network physical layer 36b. A network protocol generator 34b converts the incoming data stream into the data sent by the network protocol generator 34a of the transmitter 22. In this regard, the network protocol generator 34b is similar to the network protocol generator 34a because it can convert the data back to its original format.

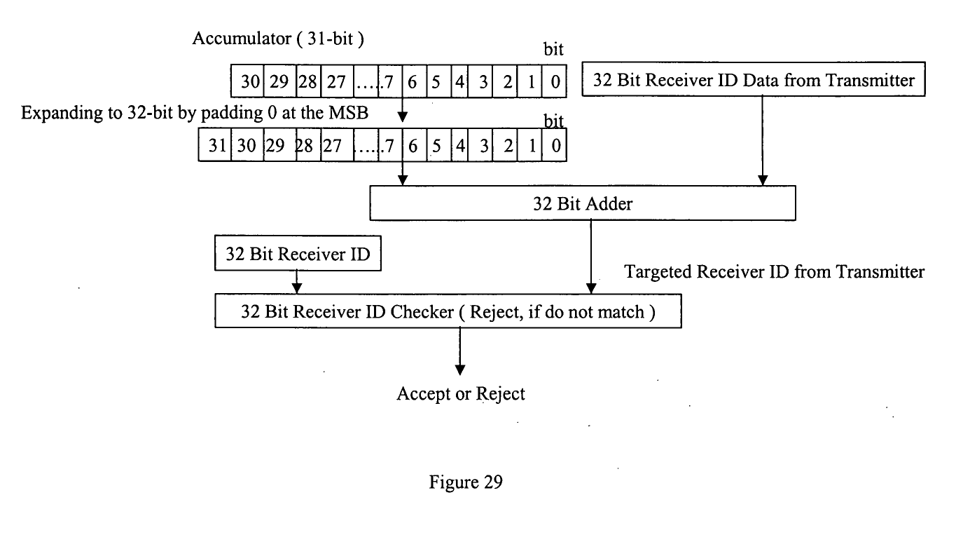

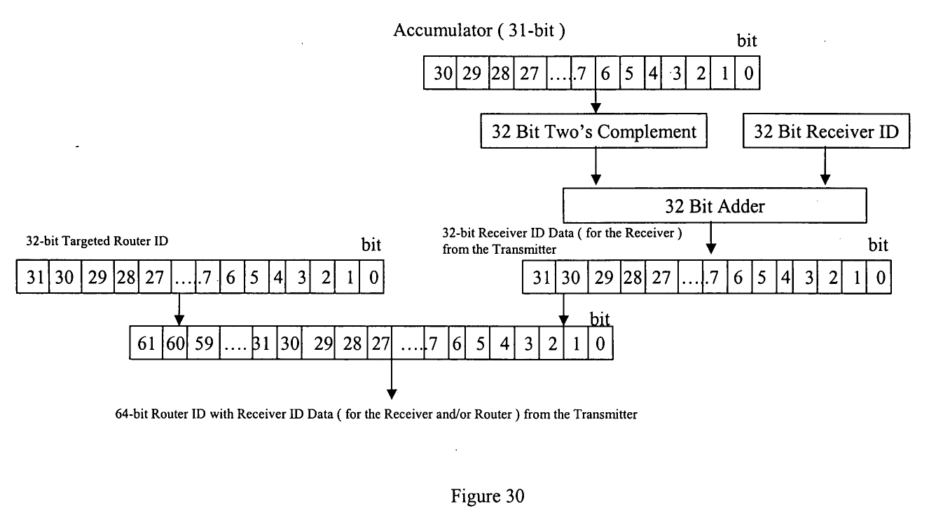

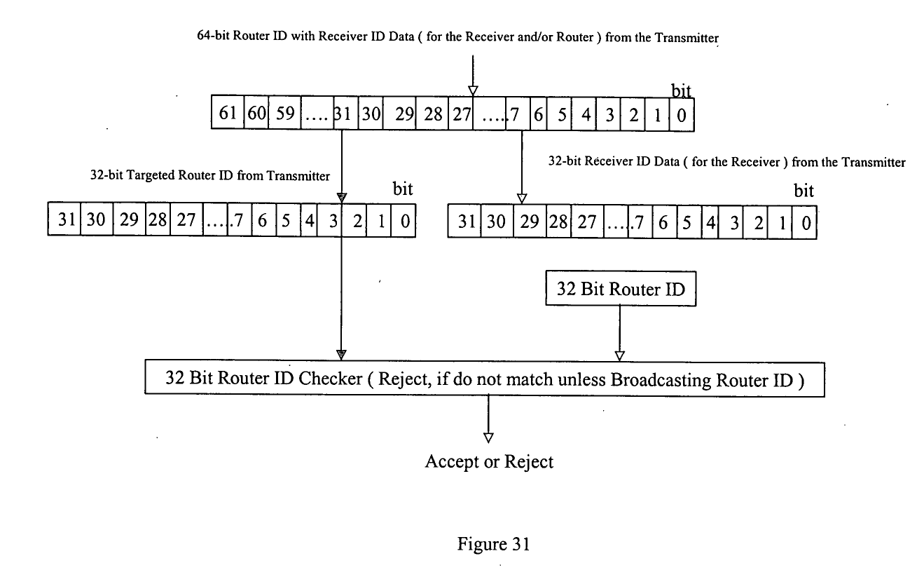

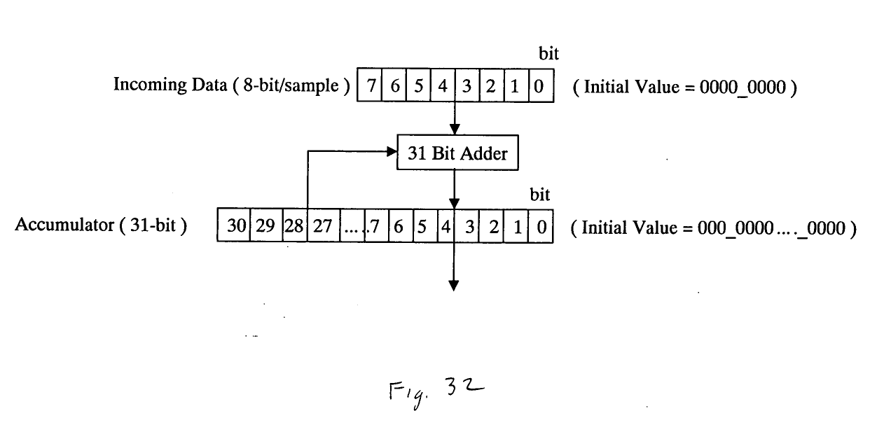

The process of determining the ID of the receiver from the data is the inverse of the process of generating the ID. The output of the network protocol generator 34b is fed into a data buffer 28b and a data sum accumulator 30b. The data sum accumulator 30b sums the incoming data and generates a 31 bit data stream. As seen in FIG. 29, the data stream can be expanded to 32 bits by padding the most significant bits (MSB) with 0. The receiver ID generator and checker 32b adds the sum from the accumulator 30b with the data received from the network. By adding the data and the sum together, the identification of the targeted receiver is generated. The receiver ID generator and checker 32b compares the identification of the receiver 38 with the generated identification from the network to determine if the data stored in the data buffer 28b is targeted for that receiver. If the identifications match, then the data is released from the buffer 28b. However, if the identifications do not match, then the data contained in the buffer 28b is not released. From the data buffer 28b, the data is sent to a digital to analog converter 40 to convert the digital data into the analog signal 26b.

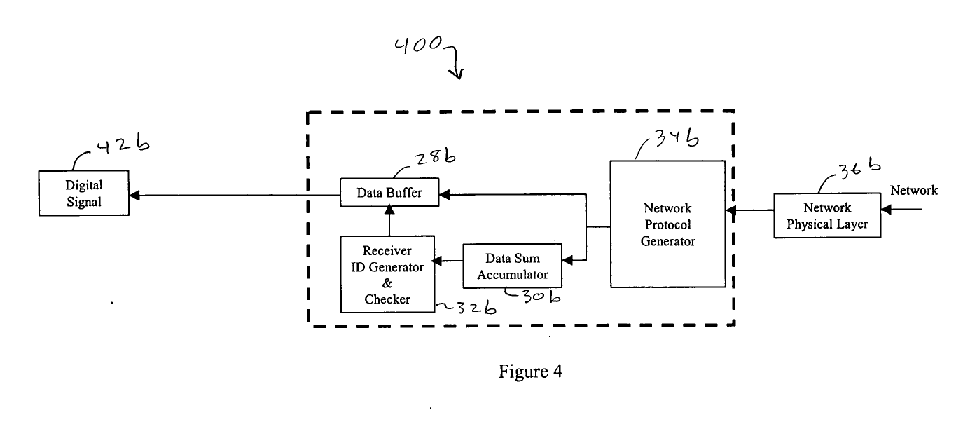

In addition to the foregoing, it is also possible to transmit and receive digital signals directly. Referring to FIG. 3, a digital transmitter 300 for transmitting digital signals directly over the network is shown. The digital transmitter 300 is similar to the analog transmitter 22 inasmuch as the elements and methods of generating the receiver ID are the same. However, the digital transmitter 300 does not have the analog to digital converter 24a of the analog transmitter 22. Therefore, the operation of the digital transmitter 300 is identical to the analog transmitter 22 except for the conversion of the input signal into a digital format. The digital signal 42a is inputted into the data buffer 28a and the data sum accumulator 30a directly. Referring to FIG. 4, the digital receiver 400 used to receive the signals from the digital transmitter 300 is shown. The digital receiver 400 is similar to the analog receiver 38 except that it does not have the digital to analog converter 40. In this regard, the digital receiver 400 directly outputs a digital signal 42b. It will be appreciated by those of ordinary skill in the art, that any combination of the analog transmitters and receivers 22, 28 and digital transmitter and receiver 300, 400 can be used because the components are nearly identical. For example, if the input source of the signal is an analog device and the device receiving the signal is a digital device, then an analog transmitter 22 would be connected to the input device, and a digital receiver 400 would be connected to the receiving device.

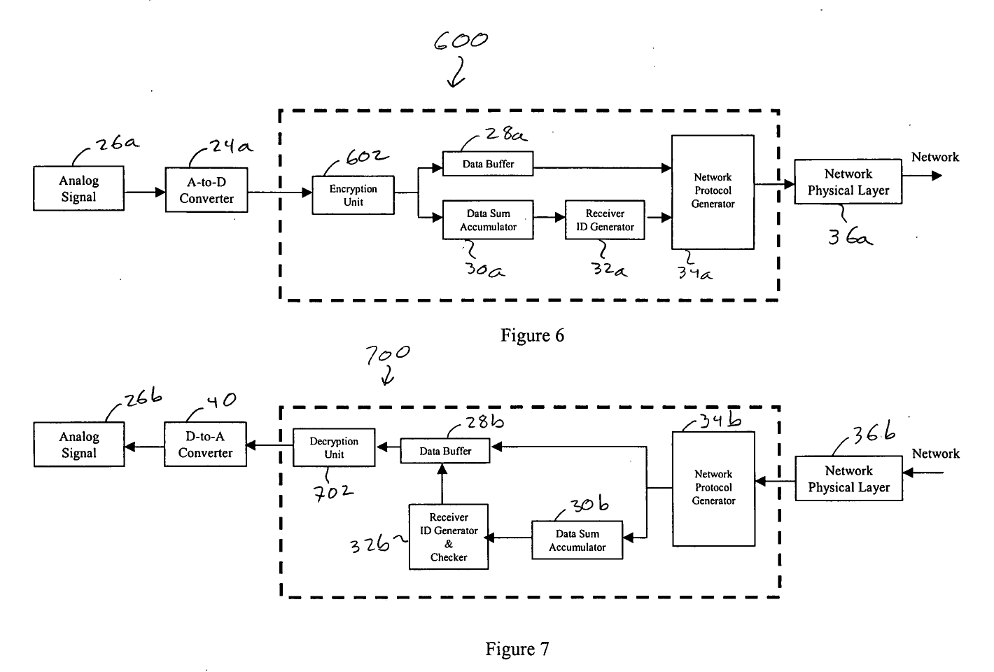

Referring to FIG. 6, an analog transmitter 600 with encryption is shown. The transmitter 600 has the ability to encrypt the signal to be transmitted. The transmitter 600 is similar to the analog transmitter 22, but includes an encryption unit 602. In this regard, the analog signal 26a is converted to a digital signal with the analog to digital converter 24a. The encryption unit 602 encrypts the digital signal before inputting it to the data buffer 28a and the data sum accumulator 30a. The encryption unit 602 can apply any type of encryption standard to the signal. The encrypted signal is then processed by the data buffer 28a, data sum accumulator 30a, receiver ID generator 32a and network protocol generator 34a as previously explained. FIG. 7 illustrates the corresponding receiver 700 for receiving and decrypting the signal. The receiver 700 is similar to the analog receiver 38 shown in FIG. 5, but includes a decryption unit 702. In this regard, the signal stored in the data buffer 28b is decrypted by the decryption unit 702 before being converted into a digital signal by digital to analog converter 40. As will be recognized by those of ordinary skill in the art, the encryption unit 602 and the decryption unit 702 will utilize the same encryption format for proper operation.

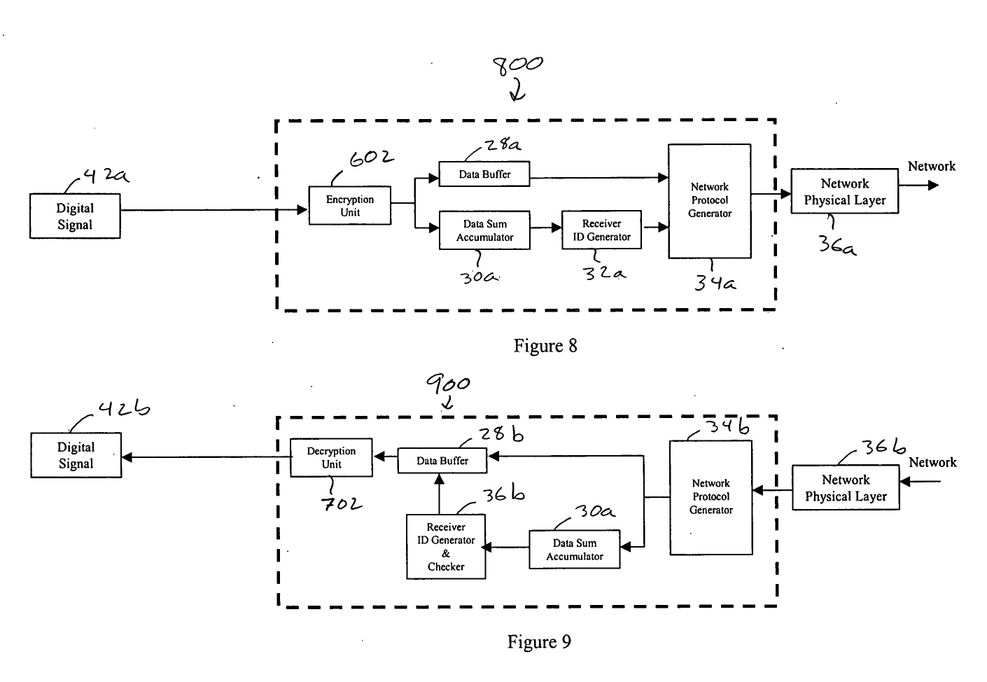

Referring to FIGS. 8 and 9, an all digital implementation of the receiver and transmitter with encryption are shown in FIG. 8. A digital transmitter 800 with encryption is shown. The transmitter 800 is similar to the analog transmitter 600 of FIG. 6 except that it does not have the analog to digital converter 24a. Similarly, a digital receiver 900 is shown in FIG. 9 and is similar to the analog receiver 700 of FIG. 7 without the digital to analog converter 40. As will be appreciated by those of ordinary skill in the art, the analog transmitter 600 and receiver 700 can be used with the digital transmitter 800 and receiver 900 in any combination depending upon the application.

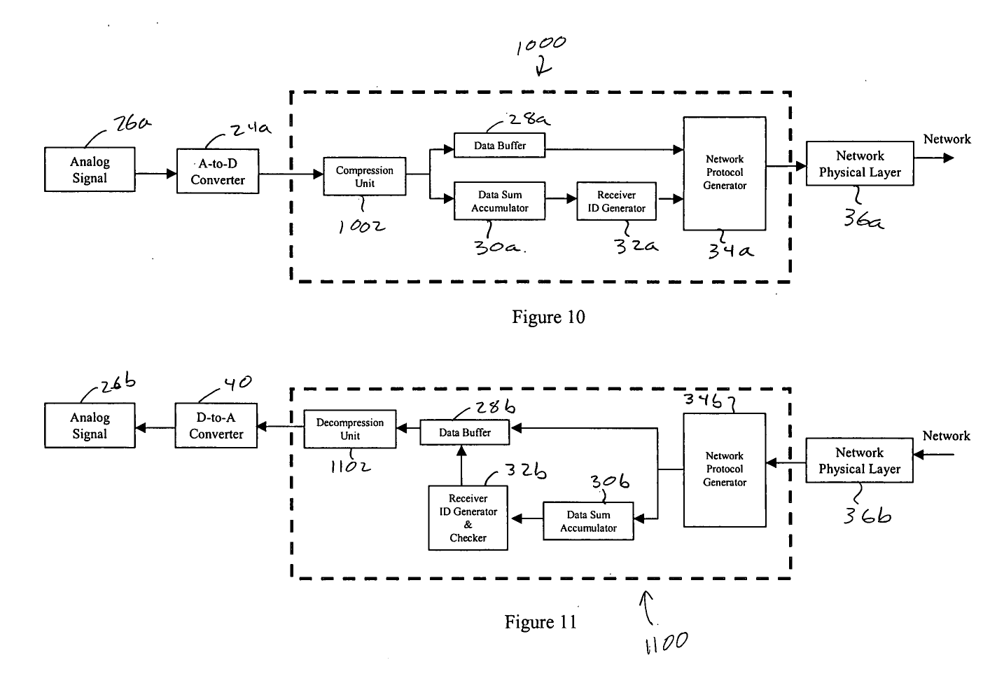

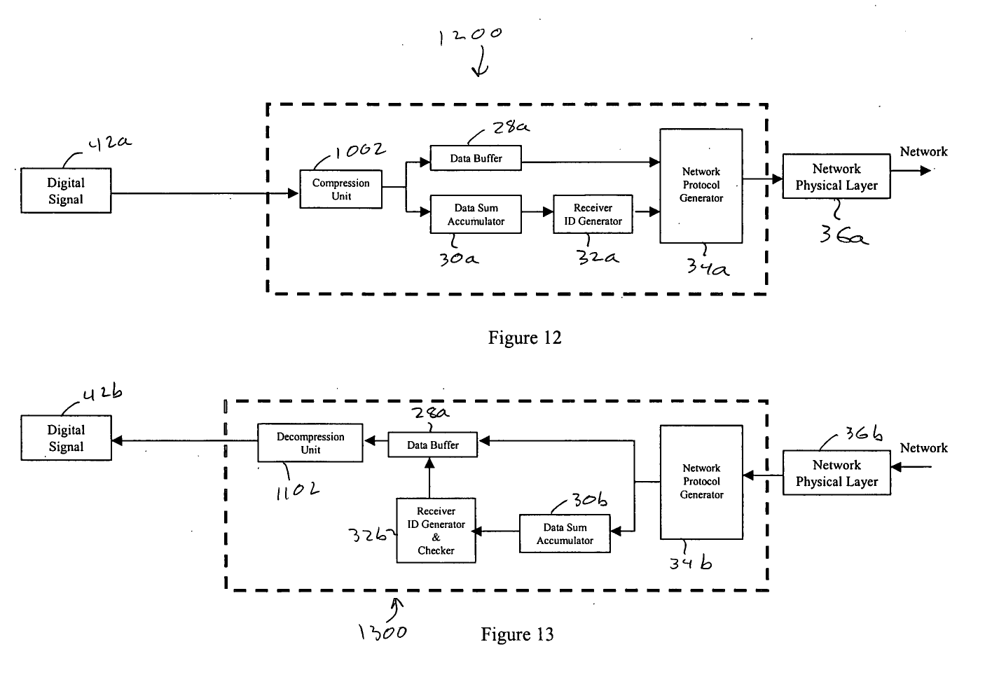

In addition to the foregoing, it is also possible to compress the signal before transmission. Referring to FIGS. 10 and 11, an analog transmitter with compression 1000 and an analog receiver with compression 1100 are shown respectively. The transmitter with compression 1000 includes a compression unit 1002 to compress the signal before processing. Similarly, the receiver with compression 1100 has a decompression unit 1102 that decompresses the signal after processing. Both the compression unit 1002 and the decompression unit 1102 need to use the same format for compressing and decompressing the signal. FIGS. 12 and 13 illustrate all digital implementations of the transmitter 1000 and receiver 1100 respectively. Specifically, the transmitter 1200 does not have the analog to digital converter 24a, while the receiver 1300 does not have the digital to analog converter 24b.

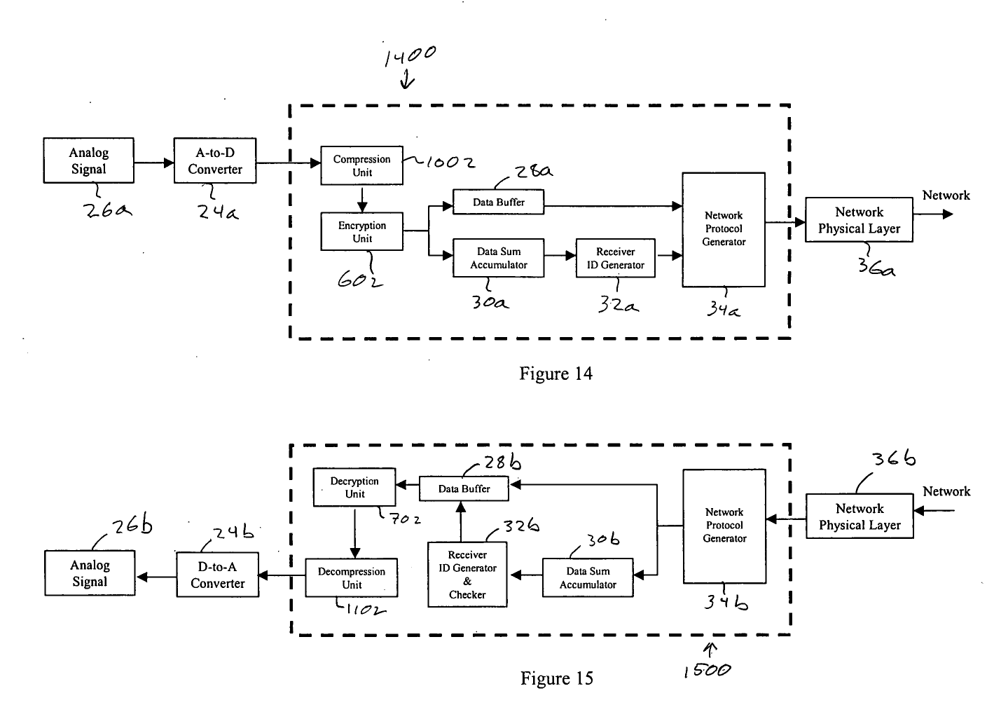

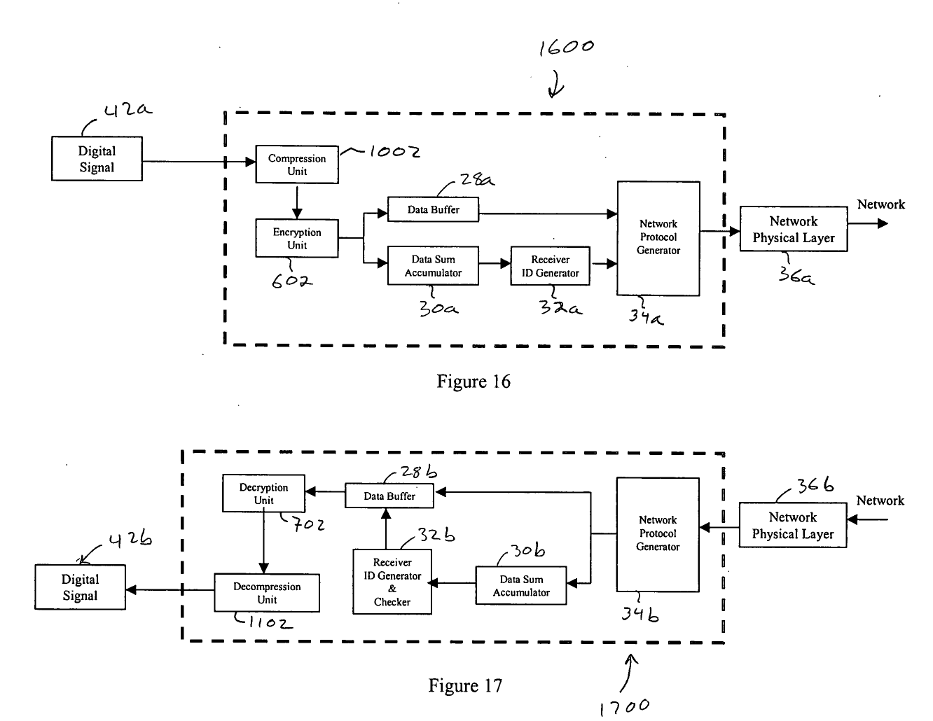

It is also possible to use both encryption and compression with the receivers and transmitters. Referring to FIG. 14, an analog transmitter 1400 with both encryption and compression is shown. The transmitter 1400 includes a compression unit 1002 for compressing the signal from the analog to digital converter 24a and an encryption unit 602 for encrypting the compressed signal. Similarly, the receiver 1500 has a decryption unit 702 for decrypting the signal from the data buffer 28b and a decompression unit 1102 for decompressing the decrypted signal. All digital implementations of a transmitter 1600 and a receiver 1700 with compression and encryption are illustrated in FIGS. 16 and 17, respectively.

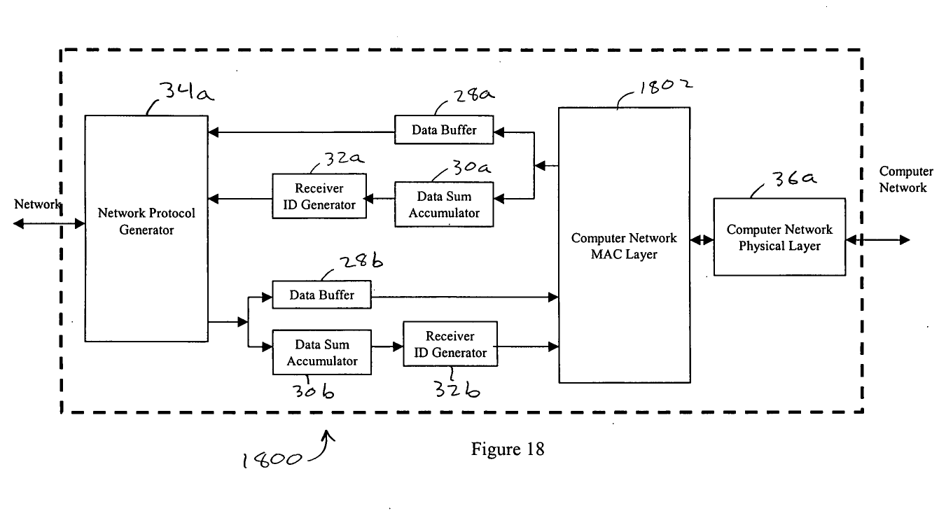

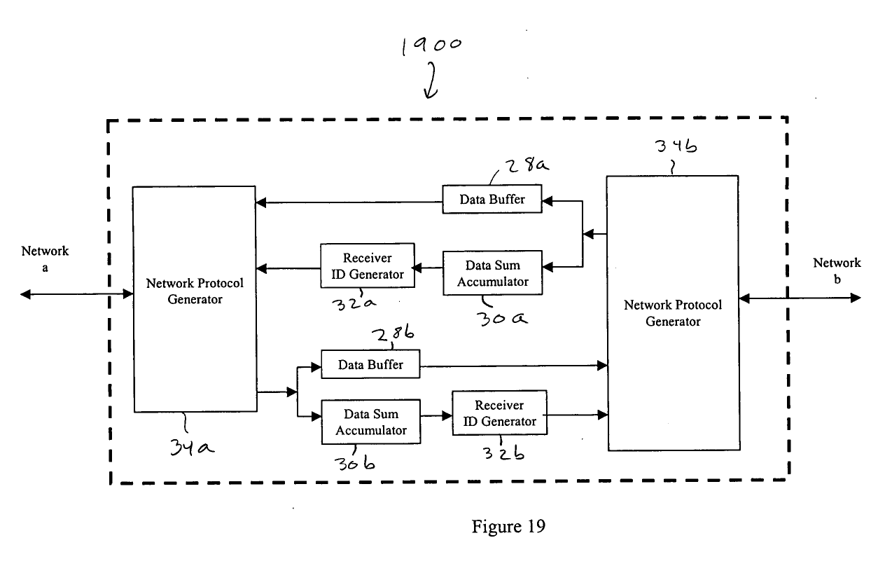

An adaptor 1800 for connecting devices into a computer network is shown in FIG. 18. The adaptor 1800 can both send and receives signals being sent over the computer network. In this regard, the adaptor 1800 configures the signals to be received by a receiver of the present invention. The adaptor 1800 has a network protocol generator 34a which formats the signals for the prescribed network. A data buffer 28b, a data sum accumulator 30b and a receiver ID generator 32b format the signals to be received by an appropriate receiver attached to the computer network. A computer network MAC layer 1802 interfaces with the computer network physical layer 36a to control and transfer the signals in the network protocol over the computer network. Similarly, signals from the computer network MAC layer 1802 are processed by data buffer 28a, data sum accumulator 30a, and receiver ID generator 32a before being inputted into the network protocol generator 34a for transmission over the computer network. In this regard, the adaptor 1800 can add the receiver ID to signals for receipt by receivers.

A router 1900 for distributing signals over computer networks is shown in FIG. 1900. Signals are received by either of the network protocol generators 34a, 34b. A data buffer 28b and data sum accumulator 30b receive data from the network protocol generator 34a and hence network “a”. A receiver ID generator 32b decodes the address identification of the incoming data. If the identification of the data matches the identification of network “b” as determined by the receiver ID generator 32b, then the data from the data buffer 28b will be transmitted to the network protocol generator 34b and hence transmission over the computer network “b”. If the identification does not match, then the data will not be transmitted from the data buffer 28b. Similarly, the data buffer 28a, data sum accumulator 30a and receiver ID generator 32a check the identification of data from network “b”. The data will be released if the identification matches the identification for network “a” as determined by the ID generator 32a. In this regard, it is possible to route data that has been formatted by transmitters of the present invention to receivers on another network.

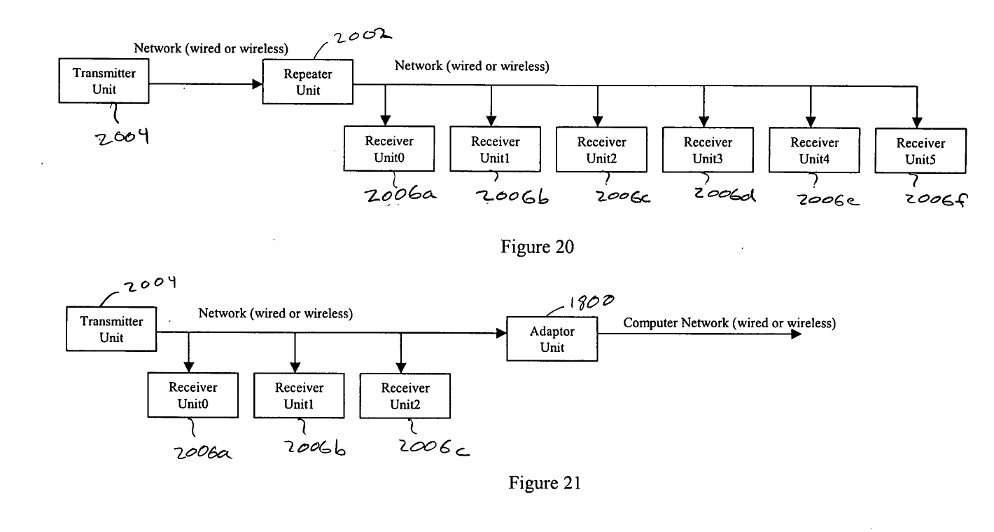

A block diagram showing how a transmitter unit 2004 communicates with receiver units 2006a-2006e with a repeater is shown in FIG. 20. The transmitter unit 2004 can be any of the analog or digital transmitters previously described, while the receiver units 2006a-2006e are any of the receivers previously described. The repeater unit 2002 is a device that repeats the data from the transmitter unit 2004 as is needed when transmitting over long distances.

Referring to FIG. 21, a network using adaptor unit 1800 is shown. In this instance, the adaptor allows the transmitter unit 2004 to connect to the computer network. Also shown in FIG. 21 are receiver units 2006a-2006c that can receive data directly from the transmitter unit 2004.

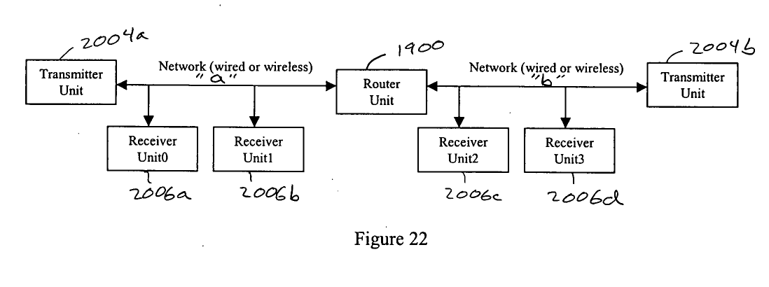

The configuration of a router unit 1900 in a network is shown in FIG. 22. The router unit 1900 connects network “a” to network “b” and allows data to pass therebetween. Therefore, data from transmitter unit 2004a can be received by receiver units 2006c and 2006d if the identification of the data matches the identification of the receiver units 2006c, 2006d as determined by the router unit 1900. Accordingly, the router unit 1900 allows the data to cross between network “a” and network “b”.

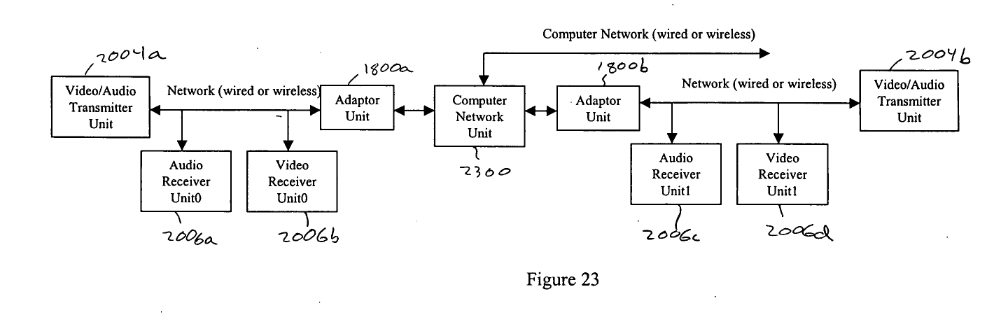

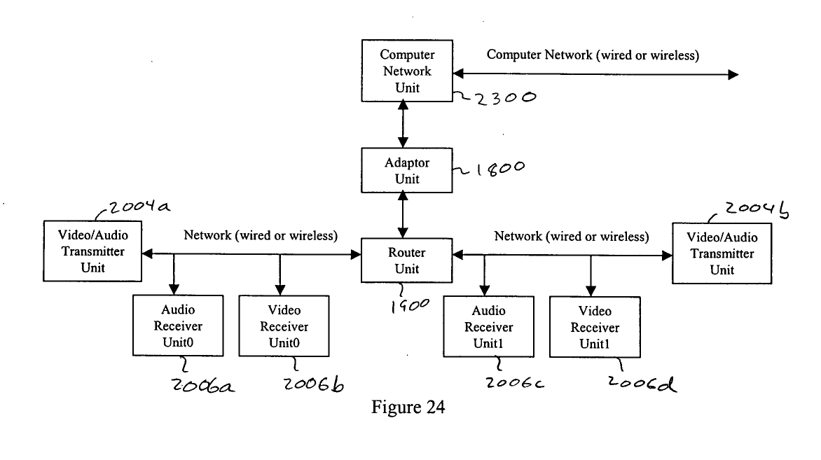

FIG. 23 illustrates how the combination of devices can be connected to deliver audio and video content over a computer network. A computer network unit 2300 interfaces with the computer network (wired or wireless). Adaptor units 1800a and 1800b convert the data from the computer network into the format that can be received by the receiver units 2006a-2006d, as previously described. Furthermore, the adaptor units 1800a and 1800b convert the data from respective transmitter units 2004a and 2004b for transmission through the computer network unit 2300. FIG. 24 is similar to FIG. 23, but includes a router unit 1900 for routing the data over the networks.

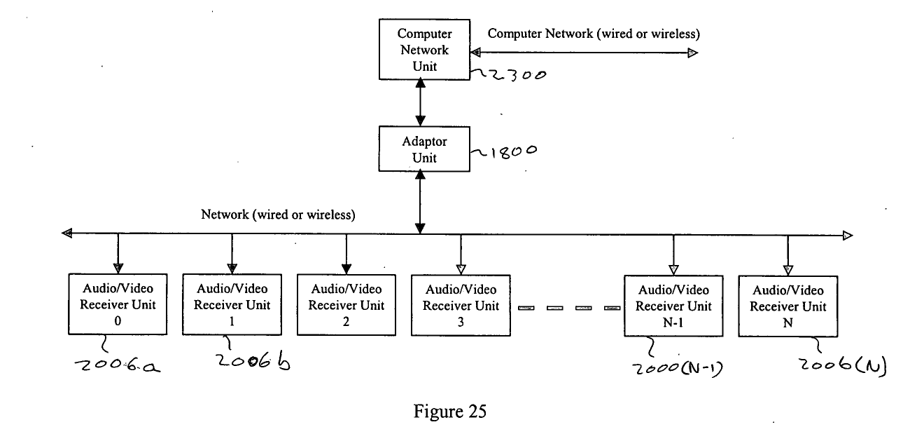

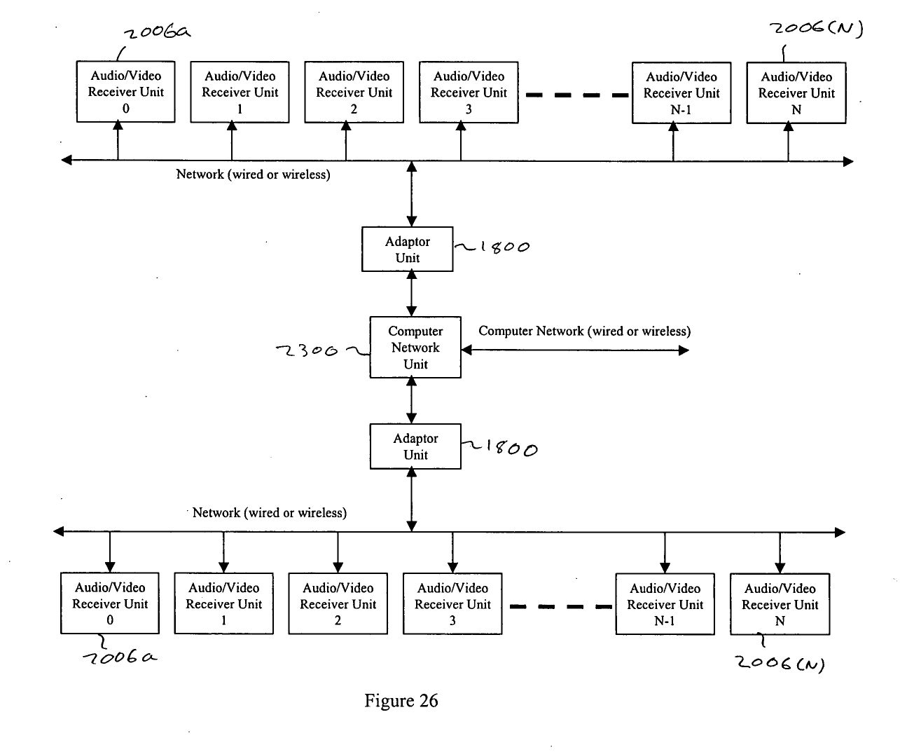

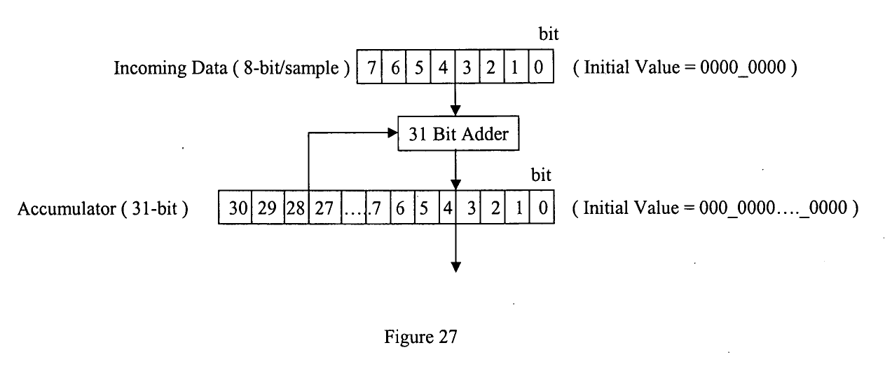

The number of receiving units is not limited by the size of the network. FIG. 25 illustrates the situation where multiple receiving units 2006a to 2006(N) are connected to the network. The number of receiving units is only limited by the number of identifications available. FIG. 26 shows an example similar to FIG. 25 whereby two networks are connected together.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalents thereof are intended to be embraced.

1. A system for communicating data between electronic devices, the system comprising:
at least one transmitter in electrical communication with a sending electronic device, the transmitter having a transmitter data sum accumulator and a transmitter identification generator for creating an identification of a desired receiver from a sum of the incoming data; and
at least one receiver in communication with a receiving electronic device, the receiver having a receiver data sum accumulator and a receiver identification generator to decode the identification of the receiver from the sum of the incoming data such that if the identification matches the identification of the receiver the data is transmitted to the receiving electronic device.

2. The system of claim 1 wherein the transmitter further includes an analog to digital converter to convert analog signals from the sending electronic device into digital data and the receiver further includes a digital to analog converter for converting the data into an analog signal.

3. The system of claim 1 wherein the transmitter further includes an encryption unit for encrypting the data and the receiver further includes a decryption unit for decrypting the data.

4. The system of claim 1 wherein the transmitter further includes a compression unit for compressing the data and the receiver further includes a decompression unit for decompressing the data.

5. The system of claim 1 wherein:
the transmitter further includes an analog to digital converter and an encryption unit to convert analog signals from the sending electronic device into digital data and an encryption unit for encrypting the digital data; and
the receiver further includes a decryption unit for decrypting the digital data and a digital to analog converter for converting the data into an analog signal.

6. The system of claim 5 wherein the transmitter further includes a compression unit for compressing the digital data and a the receiver further includes a decompression unit for decompressing the digital data.

7. A transmitter for transmitting electronic signals from a sending device to a receiving device, the transmitter comprising:
a data sum accumulator and an identification generator in electrical communication with the sending device, the data sum accumulator and the identification generator operative to create an identification of a desired receiver from a sum of the incoming data.

8. The transmitter of claim 7 further comprising a network protocol generator for converting the data into a network standard protocol.

9. The transmitter of claim 8 further comprising an analog to digital converter for converting the electronic signals from the sending device into digital data.

10. The transmitter of claim 9 further comprising an encryption unit for encrypting the digital data.

11. The transmitter of claim 10 further comprising a compression unit for compressing the digital data.

12. The transmitter of claim 7 further comprising an identification for the transmitter.

13. The transmitter of claim 12 wherein the identification is automatically generated.

14. The transmitter of claim 7 wherein the transmitter stops transmitting automatically when data is not present.

15. The transmitter of claim 7 wherein the transmitter automatically begins transmitting data when data is present.

16. A receiver for a receiving electronic device, the receiver having an identification and configured for reception of electronic signals from a transmitter of a sending device, the receiver comprising:
a data sum accumulator and an identification generator to decode the identification of the receiver from the sum of the incoming data such that if the identification matches the identification of the receiver the data is transmitted to the receiving electronic device.

17. The receiver of claim 16 further comprising a digital to analog converter configured to convert the data to an analog signal.

18. The receiver of claim 17 further comprising a decryption unit for decrypting the data.

19. The receiver of claim 18 further comprising a decompression unit for decompressing the data.

20. The receiver of claim 16 wherein the identification is automatically generated by the receiver.

21. The receiver of claim 16 wherein the receiver turns off when data is not present.

22. The receiver of claim 16 wherein the receiver turns on when data is present.

23. An adaptor for connecting an electronic device to a computer network, the adaptor comprising:
a first data buffer in electrical communication with the electronic device;
a first data sum accumulator in electrical communication with the electronic device; and
a first identification generator in electrical communication with the data sum accumulator and the computer network;
wherein the first data buffer, the first data sum accumulator and the first identification generator generate a receiver identification from the sum of incoming data; and
a second data buffer in electrical communication with the computer network;
a second data sum accumulator in electrical communication with the computer network; and
a second identification generator in electrical communication with the data sum accumulator and the electronic device;
wherein the second data buffer, the second data sum accumulator and the second identification generator generate a receiver identification from the sum of the incoming data.

24. The adaptor of claim 23 further comprising a network protocol generator in electrical communication with the electronic device and the first data buffer, the first data sum accumulator and the second identification generator, the network protocol generator being operative to convert the data signals into a prescribed network standard.

25. The adaptor of claim 24 further comprising a computer network MAC layer in electrical communication with the computer network and the first receiver identification generator, the second data buffer and the second data sum accumulator, the computer network MAC layer configured to control the access of the data to the computer network.

26. A method for communicating data between electronic devices, the method comprising the following steps:
at a transmitter of a sending device:
summing the data from the sending device and a receiver identification for generating an identification of a receiving device;
at a receiver of a receiving device:
summing the data from the transmitter to determine the identification of the receiving device; and
comparing the identification of the receiving device with the identification of the receiver to determine if a match exists.

27. The method of claim 26 further comprising the step of converting the signal of the sending device into a digital data signal.

28. The method of claim 26 further comprising the step of converting the digital data signal received by the receiver into an analog signal for the receiving device.

29. The method of claim 27 further comprising the steps of compressing the data before generating the identification of the receiving device at the transmitter and decompressing the data after determining the identification at the receiver.

30. The method of claim 27 further comprising the steps of encrypting the data before generating the identification of the receiving device at the transmitter and decrypting the data after determining the identification at the receiver.

31. The method of claim 27 further comprising the steps of compressing and encrypting the data before generating the identification of the receiving device at the transmitter and decrypting and decompressing the data after determining the identification at the receiver.

32. A system for communicating data between electronic devices, the system comprising:
means for generating an identification of a receiving device at a sending device by summing the incoming data; and
means for generating the identification of the receiving device at the receiving device by summing the incoming data.

33. A router for connecting a first and second networks, the router comprising:
a first network protocol generator in electrical communication with the first network;
a first data buffer in electrical communication with the first network protocol generator;
a first data sum accumulator in electrical communication with the first network protocol generator;
a first identification generator in electrical communication with the data sum accumulator; and
a second network protocol generator in electrical communication with the first identification generator and the second computer network;
wherein the first data buffer, the first data sum accumulator and the first identification generator generate a receiver identification from the sum of incoming data; and
a second data buffer in electrical communication with the second network protocol generator;
a second data sum accumulator in electrical communication with the second network protocol generator; and
a second identification generator in electrical communication with the data sum accumulator and the first network protocol generator;
wherein the second data buffer, the second data sum accumulator and the second identification generator generate a receiver identification from the sum of the incoming data.

34. A method for generating an address of a receiver from a stream of data and a receiver identification, the method comprising the steps of:
summing the data stream; and
generating the address from the sum of the data and the receiver identification;
wherein the address corresponds to the identification of the receiver.
